(19) United States
(12) Patent Application Publication
(10) Pub. No.: US 2008/0319788 A1
(43) Pub. Date: Dec. 25, 2008

(54) METHOD AND SYSTEM FOR ANALYZING COSTS TO A PLAN MEMBER UNDER MEDICARE

(76) Inventor: Edward A. Ross, Needham, MA (US)

Correspondence Address: Kristina M. Grasso;Kristina M. Grasso, Esq. PLLC, P.O. Box 162, Milford, NH, 03055, US

(21) Appl. No.: 12/121,737

(22) Filed: May 15, 2008

Related U.S. Application Data
(60) Provisional application No. 60/938,024, filed on May 15, 2007.

(51) Int. Cl. G06Q 50/00; G06Q 10/00

(52) U.S. Cl. 705/2

(57) ABSTRACT

A method for facilitating an easy and practical detailed analysis of Medicare Part D plans that saves the user time in calculating what a single plan costs by analyzing and presenting data regarding actual and estimated drug costs under various healthcare plans and features. A list of prescription drugs likely to be used in the coming year is prepared, including dosage and frequency of use on a personalized template. Information is added to the forms generated from the template, including plan name, prices for initial coverage, and yearly fee and deductible, for each plan. The spreadsheets are analyzed to compare plans. The effect on yearly cost of options such as home delivery, non-formulary drug suppliers domestic and foreign, which local drugstores, and other health decisions may be taken into consideration. Experts may then be consulted on ways to save money without losing any health benefits.

### RELATED APPLICATIONS

This application claims the benefit of U.S. Provisional Patent Application No. 60/938,024 filed May 15, 2007, which is herein incorporated in its entirety by reference.

### FIELD OF THE INVENTION

The methods and systems in this application generally relate to managing drug costs, and in particular relate to managing drug costs under the Medicare Part D Plan.

### BACKGROUND OF THE INVENTION

Medicare Part D Plan provides various coverage options for its members to manage drug costs. The benefits, plans, coverage options, drug costs, premiums, deductibles, and any other limit or value reflect data for the published 2007 plan year. Any and all of this information may change at least yearly if not more often. A practical way to use Medicare Part D effectively is to use the Medicare website, which offers the data on all of the drugs offered by the plans. The cost to the plan member may be divided into three areas:

1.) The annual premium that may be paid in monthly installments ranging in price from $106.80 to $1048.60;

2.) The deductible is the amount paid by the subscriber before drugs are covered. By law, it was capped at $265 for 2007. Most plans either charge zero or the full $265; and

3.) The drug costs are what users pay for drugs. They are paid for at varying rates. The rates are as follows:

a. The Initial Coverage Limit (ICL) rates are charged to the user by the insurer as long as the total amount paid by the user plus the amount paid by the insurer is lower than a set amount. In 2007, that figure was $2400.

b. The Full Cost of the Drug is the price paid when the user has exceeded the ICL limit. This is informally known as the “doughnut hole” price.

c. The Catastrophic Coverage Price is the amount the user pays after the True Out of Pocket Cost (TrOOP), which exceeded $3850 in 2007. The Catastrophic Coverage Prices to the user are about five percent of the Full Cost of the Drugs. The total TrOOP cost comprises the personal expense portion of the expenditures during the first $2400 of full cost plus the total cost, paid by the user, after the ICL is exceeded. Drugs not on a specific plan's formulary are not available to the user under the plan. If the user buys drugs outside of a plan's formulary, he pays the full price. It is as if the purchases were never made, as far as the plan is concerned. These purchases do not count toward the user's ICL, and so they do not get one closer to the doughnut hole. Purchasing drugs not on the formulary also does not contribute to reaching the $3850 TrOOP expenditure level, after which drugs are much cheaper in the Catastrophic Coverage area. However, the user does not have to buy the drugs from the designated pharmacy. He or she can buy from any source that supplies the drugs. Some drugs are available much cheaper than the full price from foreign drug companies and some domestic companies. Some drugs are also cheaper than the initial cost to the user under the plan.

A practical way to use Medicare Part D effectively is to use the Medicare website where data on all of the drugs offered by the plans can be found. The drugs and prices that are on the formulary of each plan available in the area are available, with their TrOOP prices, ICL or “full prices”, and Catastrophic Coverage prices. FIGS. 7A-7E are pictures of the pages on the Medicare website that presents price data for the AARP plan that we use in our illustrations.

Medicare does estimate the total cost of each plan to the user. It does not explain how it computes these costs. Although they are not bad for the AARP plan, they are ludicrous for many of the other plans. Medicare does not provide any system to observe the effect of changing drug and supplier selection.

The Medicare website is so difficult to use that even computer professionals have given up trying to understand it, and rely instead on their hunches. It would be a daunting task for any user to analyze data from every one of the plans from scratch.

### SUMMARY OF THE INVENTION

It is a goal of the present invention to facilitate an easy and practical detailed analysis of Medicare Part D plans and save the user time in figuring out what a single plan costs. A list of prescription drugs likely to be used in the coming year is prepared, including dosage and frequency of use on a personalized template. Information is added to the forms generated from the template, including plan name, prices for initial coverage, and yearly fee and deductible, for each plan. The spreadsheets are analyzed to compare plans. The effect on yearly cost of options such as home delivery, non-formulary drug suppliers domestic and foreign, which local drugstores, and other health decisions may be taken into consideration. Experts may then be consulted on ways to save money without losing any health benefits.

### BRIEF DESCRIPTION OF THE FIGURES

The invention and the following detailed description of certain embodiments thereof may be understood by reference to the following figures:

FIG. 1 depicts a basic template with no personal data. Each person who uses the invention will start from this point.

FIG. 2 depicts a personal template.

FIG. 3 depicts a completed personalized form from an individual's projected expenditures in 2007 using the AARP standard plan, which is the most popular plan.

FIG. 4 depicts FIG. 3, except that Beconase® is purchased in a generic version as beclomethasone from a Canadian company.

FIG. 5 depicts the basic template with the formulas made visible, but without data.

FIG. 6 depicts the personal template with formulas made to appear, but without data.

FIGS. 7A-7E are pictures of the pages on the Medicare website that presents price data for the AARP plan.

FIG. 8 is a flow chart illustrating the methodology of an embodiment of present invention.

### DETAILED DESCRIPTION OF THE INVENTION

The invention may utilize spreadsheet functionality, such as may be embodied in spreadsheet software that may run on a computing facility such as a computer. The invention may be embodied in a computer program that may be stored in a computer memory and may be executed by a processor by following the steps and methods herein disclosed. For example, and without limitation, a basic template may be provided that can be employed by any Plan D user. From this, sub-templates may be made to fit each specific user.

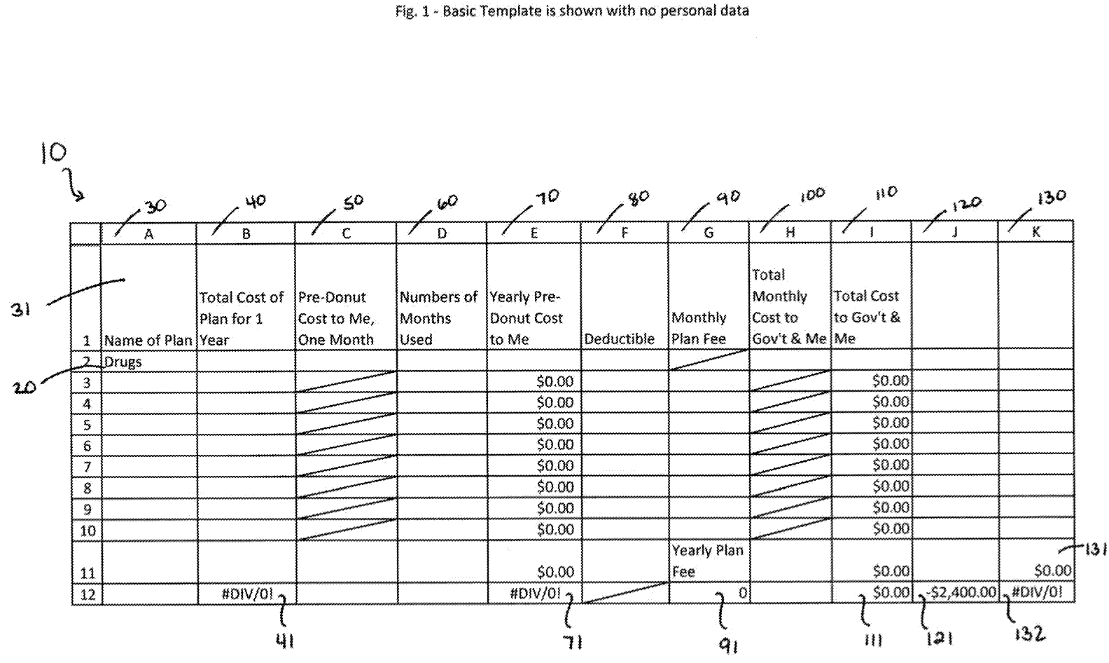

Referring to FIG. 1, the basic template 10 is shown with no personal information data. The user will start from this point. Basic template 10 will be made into a personal template by each user by entering personal data, such as drugs 20 and/or quantities.

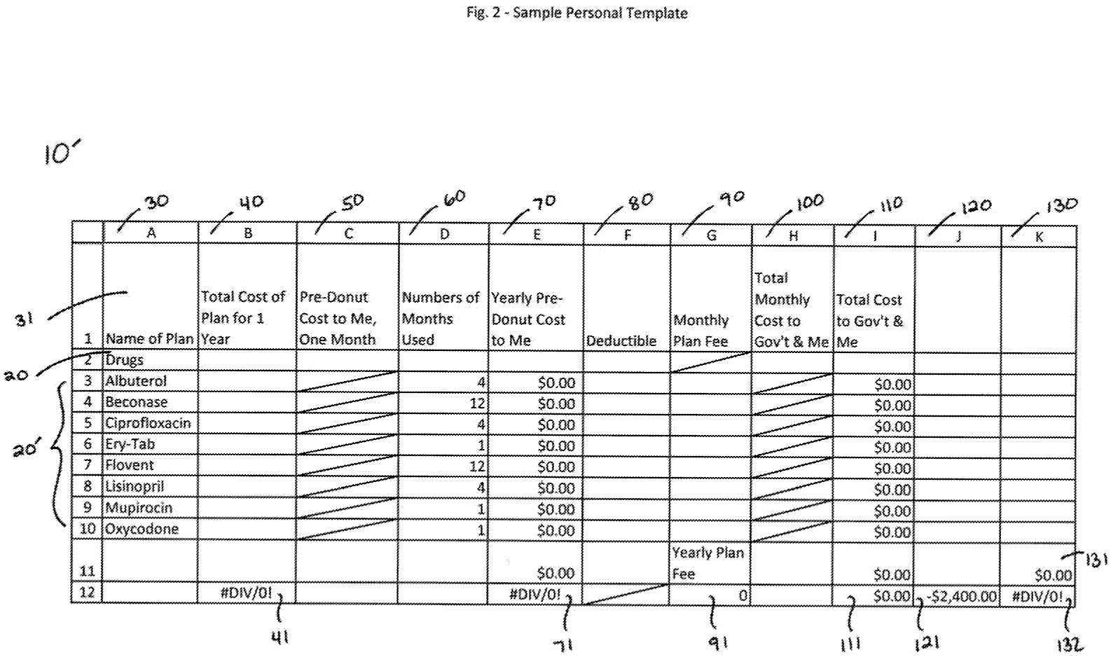

Referring to FIG. 2, the personal template 10′ may be made from basic template 10. It now includes in column A 30, the names of the drugs 20′ the user expects to use in a prescribed time period, i.e.: a year, and in column D 60, the number of months in which the user will have the each prescription refilled. The term “number of months used” conforms to the terminology used in the Medicare website. It represents the number of times the prescription may be filled. It would be possible to use more than one refill per month. The user will enter different drugs and different frequencies of use. By way of example, the cells with double line borders are the ones into which the user will enter the name of a plan to be evaluated and the data, including the prices of the drugs, the cost of the drugs and the fees to be paid.

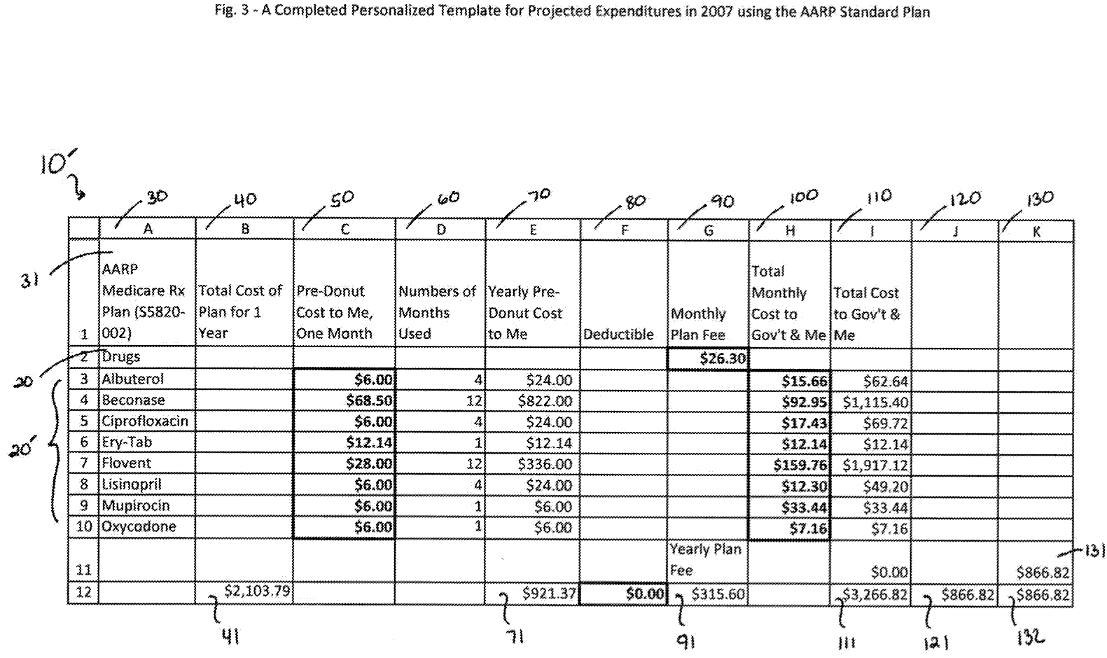

Referring to FIG. 3, the prices have been obtained from the Medicare website. In this example, the user's net expenditure for prescription drugs, as seen in column B 40, cell B12, will total $2,103.79 if nothing unexpected happens. The figures at the bottom of the column I 110, headed “Total Cost to Gov't and Me”, represents what the user would spend if the user had no plan and bought American drugs. At $3,266.82, shown in cell I12, it is the ICL, the total expenditure for drugs at retail prices. This is nearly $1200 more than the total the user would spend under this plan. The user's total expenditure under this plan is shown in cell B12 at the bottom of the second column, $2103.79.

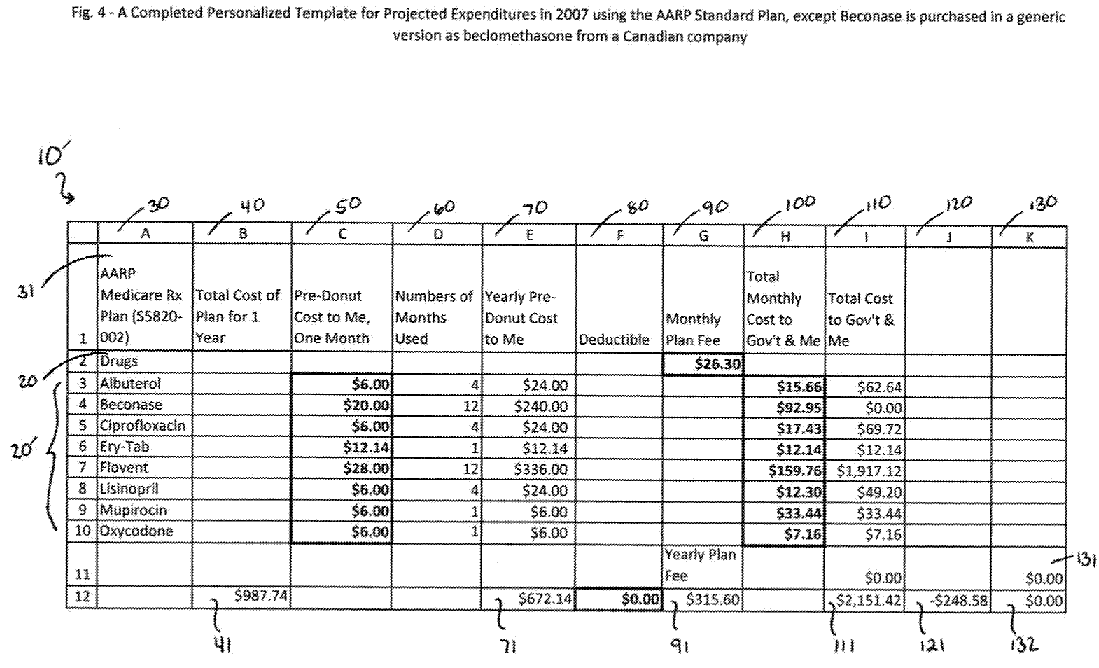

Referring to FIG. 4, the drug Beconase®, cell A4, is available in generic form in Canada. There is widespread agreement that generic drugs are the same as the branded product. The price of the Canadian drug is less than $60 for a package of three, including shipping. The total cost for the beclomethasone under the plan is $92.95 a month as shown in cell H4 of FIG. 3. FIG. 4 reflects the user buying this medication outside of the plan, so the ICL cost to the government and the user is zero. The user has substituted zero for the ICL cost of the beclomethasone in column H 100. This is reflected in cell H4, which is “0”.

Referring further to FIG. 4, it seems paradoxical that the user can save more than $1100 by buying generic Beconase® from Canada at a price that is only $540 lower for a year's supply than the American branded product. This is because the user stays out of the “doughnut hole”. Even the branded version is available in Canada for only $40, so the user would still save about $800 by using the Canadian drug. Note that under column H 100, the “Total Cost to the Gov't and Me”, the cost of beclomethasone is now “$0.00.” This column is actually the TrOOP expenditures, the True Out Of Pocket expenses. The TrOOP cost is what determines when you can get past the doughnut hole, and into the catastrophic coverage area. The user and potentially a vast majority of senior citizens do not come near the catastrophic coverage area. Many are concerned about getting into the doughnut hole. The TrOOP does not directly affect getting into the doughnut hole. That is the ICL as mentioned previously. It is the TrOOP that may facilitate getting the user out of the doughnut hole and into the very low cost price catastrophic coverage area.

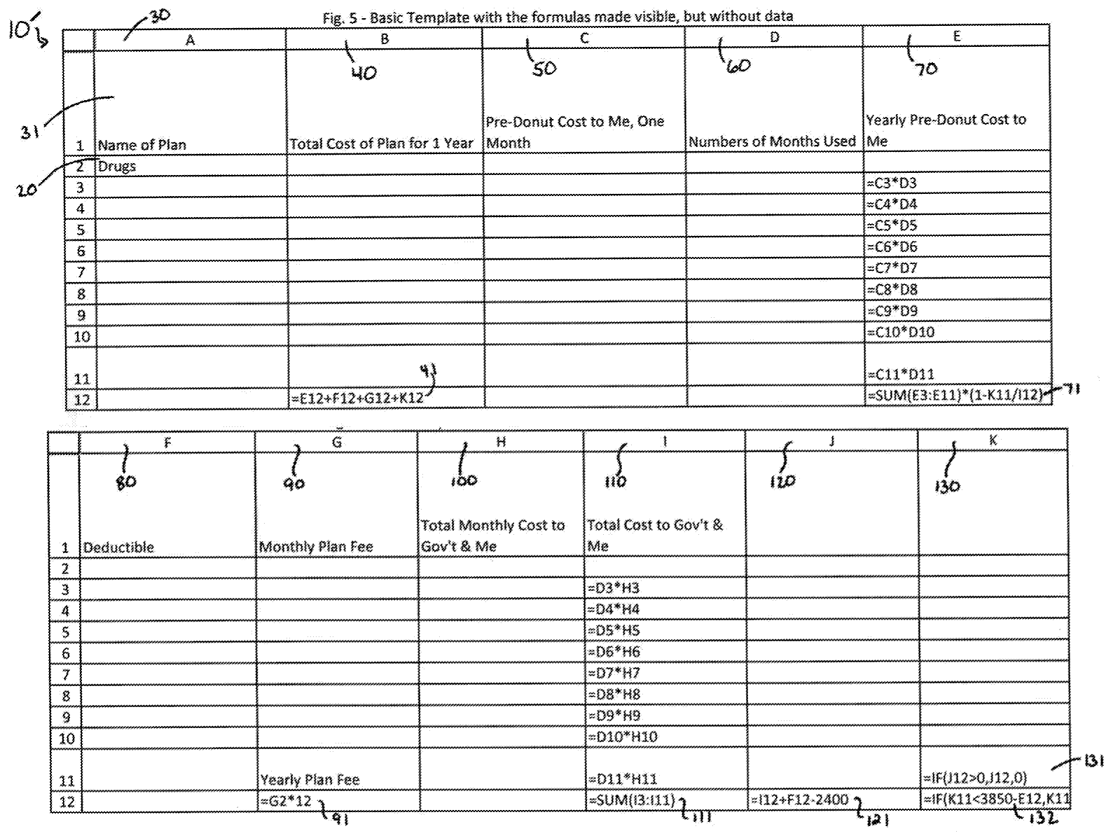

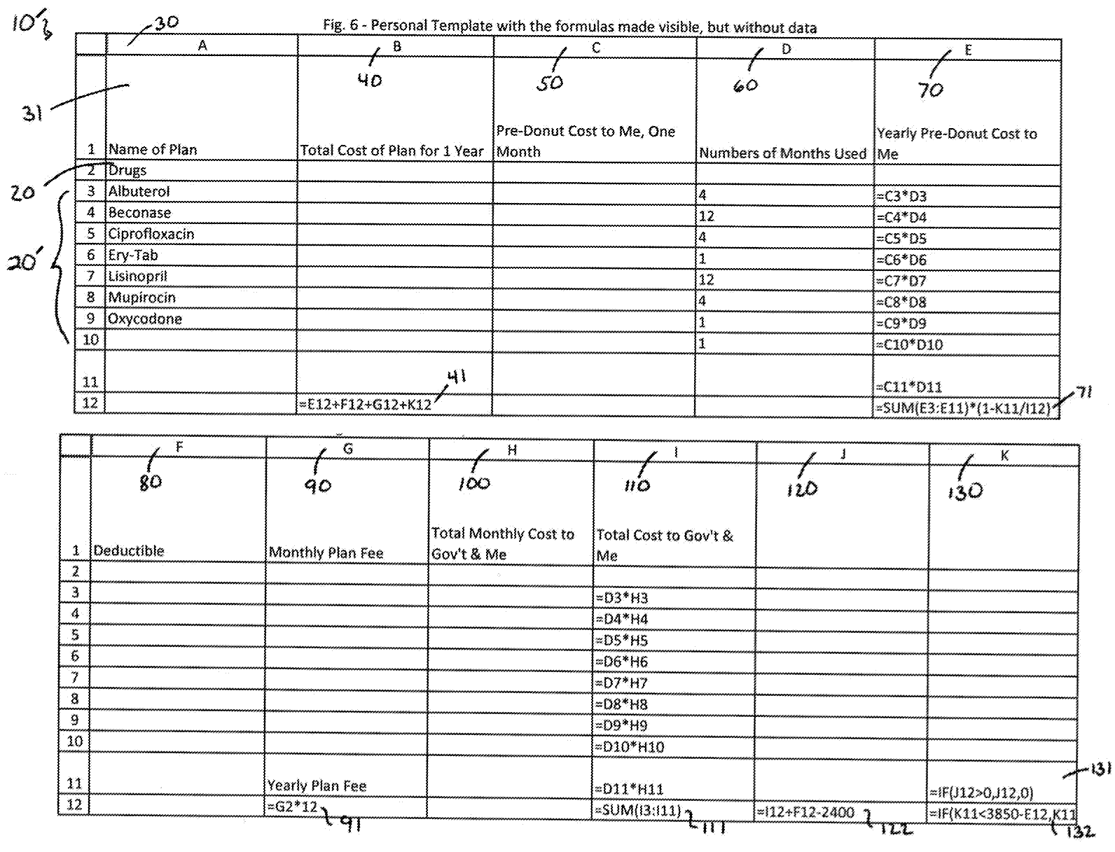

It is further noted that, in this example, one could convert the template in FIG. 4 to the template in FIG. 3 by changing the “$20.00” for Beconase® in column 3 row 4 to $68.50 and the “0” in the column 9 row 4 to the formula “=D4*H4”. FIGS. 5 and 6 provide the formulas.

Referring again to FIGS. 1 and 2, most of the numbers in the chart are “$0.00”. This is because there is no input price and no plan fee data. This data has been entered in FIGS. 3 and 4. With these inputs, the cost of the plan is calculated automatically by the formulas in the templates and the result is represented in FIG. 3. In FIG. 4, the entries in the template have been modified by including pricing for a Canadian drug.

The forms and templates may contain formulas in the cells and those cells may exhibit “$0.00” when there is no data in cells in the templates that are related to the formulas. FIGS. 5 and 6, show these formulas instead of the $0.00 default value. To facilitate viewing the formulas in FIGS. 5 and 6, the formulas have been entered in the spreadsheet cells as text rather than formulas. Using the text, however, means that this is not a working file; it is only an illustration for pedagogical purposes.

In FIG. 6, a personal template with the formulas visible and, with the user's drugs listed. As in FIG. 5, the formulas have been made to appear. There is no numerical data. The TrOOP drug prices will be entered into column C 50 for each drug. The prices in this column are what the plan member will be paid before reaching the ICL limit, at which point the user enters the “doughnut hole” and pays the full cost. Column D 60 lists the expected usage of each drug during the calendar year. In column E 70, the cost of each drug is multiplied by the number of months it will be used. The sum of these costs will appear in cell E12.

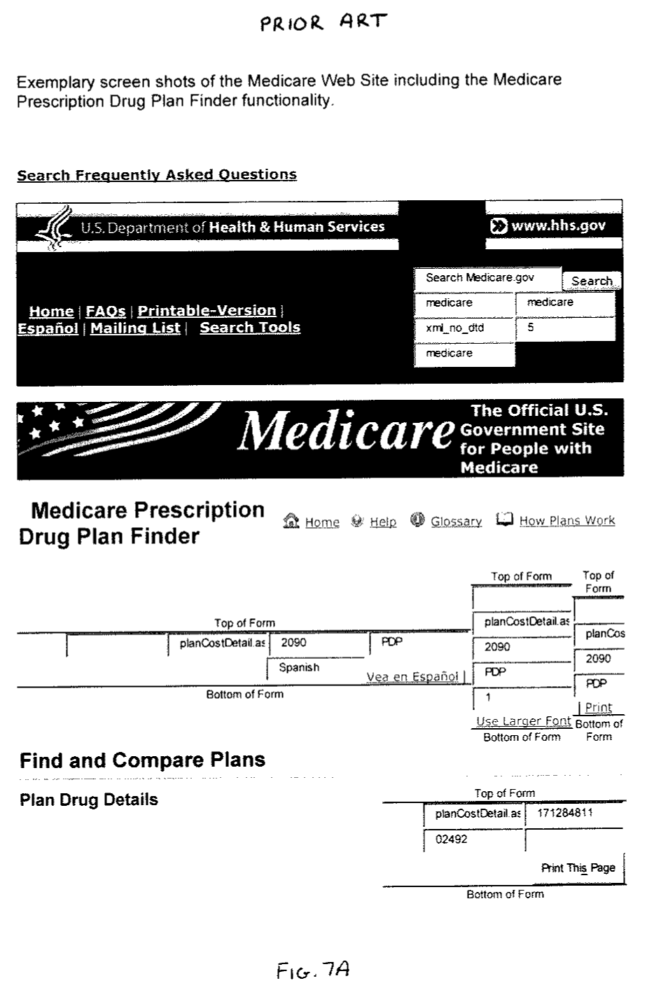

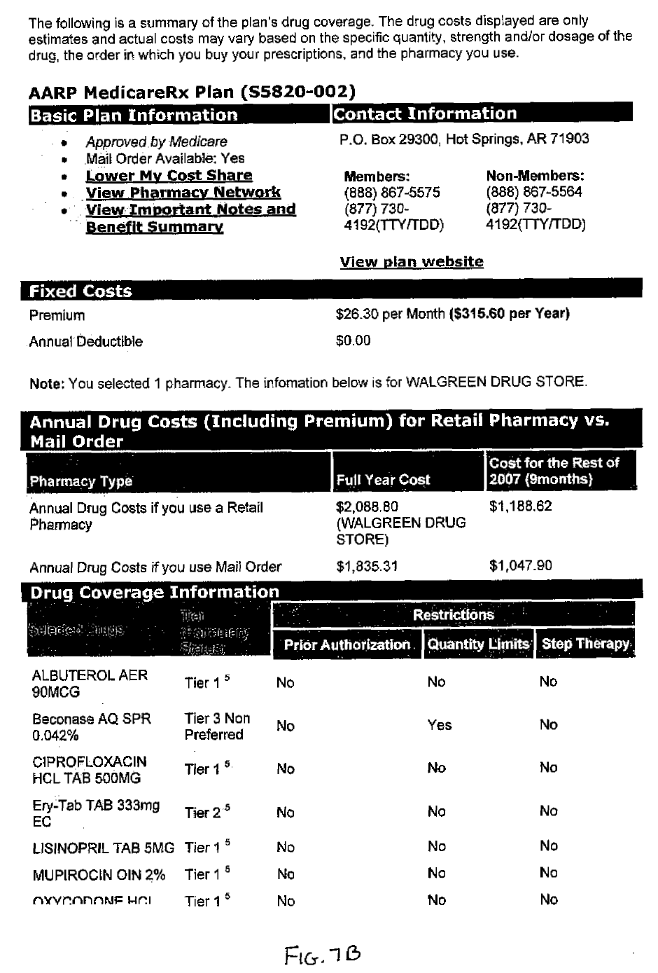

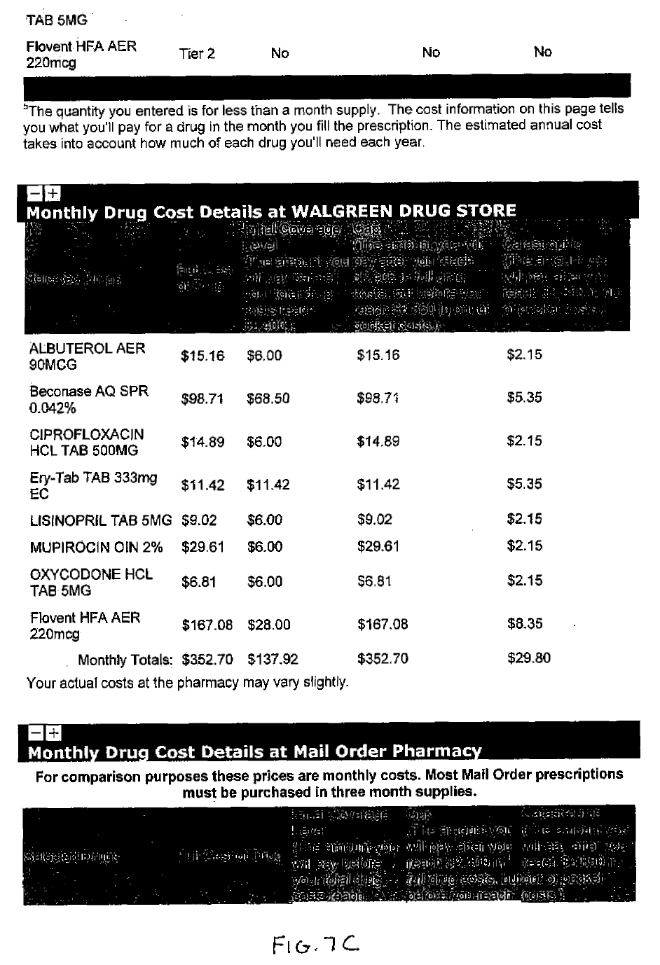

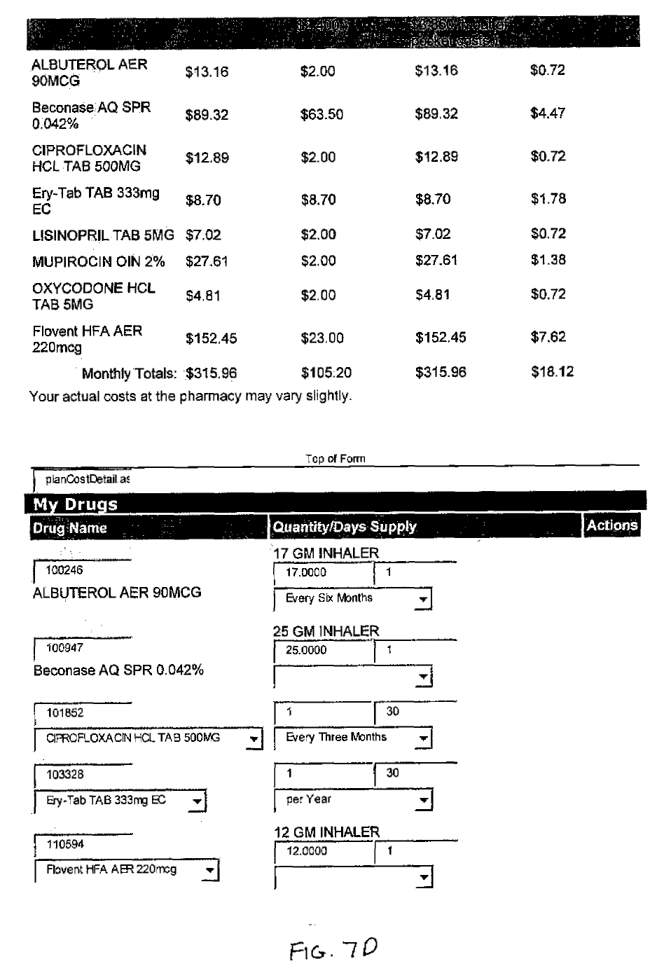

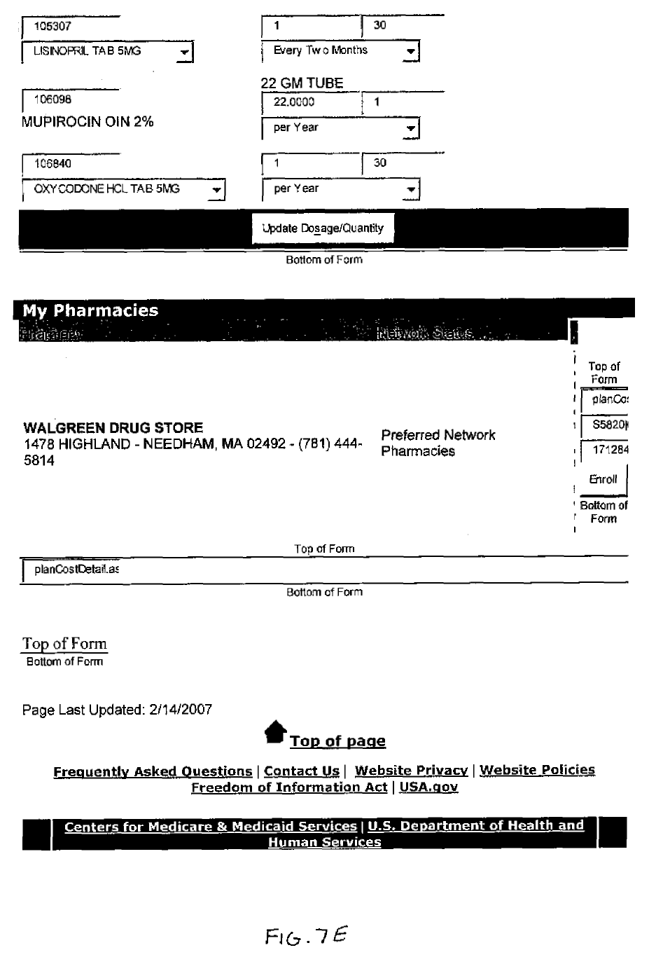

To provide further explanation of a method of the invention, a more detailed, column by column discussion of the formulas in FIG. 6 and the corresponding values in the corresponding cells shown in FIG. 3 is presented by way of example, without limitation. Reference is further made to FIGS. 7A-7E hereto, which are sample pages of the Medicare website. Column A 30 contains the user's medicines. The medicines in column A 30 may only change when the user's conditions change. Two of the user's medicines, Flovent® and Beconase®, are long term asthma and hay fever medications that the user takes regularly, and has for years. The albuterol, ciprofloxacin and lisinopril are ‘as needed’ medicines for specific conditions; 4 per year are estimated. The once-per-year prescriptions are for unexpected occurrences, such as a root canal infection preventative and a painkiller. It is anticipated that the user needs a few such miscellaneous medications most years, and the estimates of drug expenditures are somewhat improved if they are included in the estimates.

Referring to FIG. 3, Cell A1 of Column A 31 contains the name of the plan being evaluated. In this case it is the most popular plan, the AARP standard plan. Column B 40 is a total cost of the plan for the year. It is the sum of the four components that are added together in cell B12 41, as shown in FIG. 6. Column C 50 lists the prices of the drugs under the specific plan, in this case AARP Standard. These are the prices to the user before the total payments reach the ICL (Initial Coverage Limit), $2400 in 2007. Column D 60 lists the probable number of purchases for each drug. Column E 70 lists the product of column C item quantities multiplied by the prices from D3 to D11.

In this example, what is needed in cell E12 71 is the amount that will be spent at the pre-doughnut hole level. This amount will contribute to the TrOOP total ($3850 in 2007), that will switch the prices from full cost to the very cheap catastrophic level. The other part that contributes to the TrOOP total consists of the payments made after the $2400 ICL total is reached. From that point until the TrOOP total reaches $3850, the user pays all of the expenses at full cost prices, so they all add to the TrOOP. If the user does not reach the ICL, E12 will serve fine as the sum of E3 to E11. If full-price drug expenditures do exceed the $2400, then some of the figures in Column E will be paid at the full price. In that case, if the whole of column E was included, the column E expenditures would be double-counted. In this example, the formula used in E12 is, therefore, E12=SUM(E3:E11)*(1−K11/I12). Cell I12 111 is the sum of the full cost of the drugs used under the plan. K11 131 is the sum of the full payments less the ICL limit. So K11/I12 is the proportion of the drugs used after the IC limit is reached. Subtracting this fraction of the drugs from the sum of the figures in column C leaves the expenditures, before the ICL is reached. This is accomplished by multiplying the E column total by (1−K11/I12). If the $2400 ICL is not reached, K11 will equal 0 and so K11/I12 is zero, and the column total is multiplied by 1.

Furthering this example, column F 80 is where the amount of the plan's “deductible” is entered. This plan does not have a deductible, so the value here is 0. If there is a deductible, it is charged against first expenditures in the year at the full cost prices. It adds to the ICL total, as well as to the total in B12. Column G 90 is the yearly total of the monthly plan fees as seen in cell G12 91. It is the monthly plan fee in cell G2 times 12. The fees are part of the price of the plan and are added to B12, but they are added to neither the TrOOP nor the ICL totals. In Column H 100, the full price of each drug is entered. In Column I 110, the figures in Column H are multiplied by the number of times each will be used in column D, to produce the total cost to the government and the user. Cell 112 is the total full cost of the drugs, no matter whether they are paid by the subscriber or the insurer. In column J 120, cell J12 121, $2400 is subtracted to calculate the amount by which the $2400 ICL limit is exceeded. The deductible is also added. In column K 130, cell K11 131 an “IF” function is used. “=IF(J12>0,J12,0)” is put into K11. This means that if J12 is greater than zero the value in J12 is entered; it will be over the ICL limit. The amount is what the user must pay for at full cost until the user is over the TrOOP limit. If the number is less than zero, the IF function enters a zero. A zero, rather than a negative value, is needed. The user cannot deduct anything. The Plan charges a stiff fee to exceed the ICL, but does not deduct anything if the plan member is under it.

In K12 132, the IF function is used again. If the total cost of the drugs is more than $2400, the excess over $2400 is paid entirely by the plan member until the plan member has paid $3850 of his or her own money, after which Medicare pays 95%. It has been estimated that very few plan members get into the five percent cost bracket of catastrophic coverage. The calculation used in K12 is: =IF(K11<3850−E12, K111,(3850−E12)+0.05*(K11−(3850−E12))). This means if K11 is less than “3850−E12” which is the TrOOP level that gets the plan member beyond the doughnut hole, the value of K12 equals K11. If K11 is more than this value we use (3850−E12), the TrOOP limit, and add to it 5 percent of the portion of actual amount of K11 less the TrOOP limit. Although the Plan D providers round the numbers up a little from there, in their favor, the 5 percent estimate serves very well. See FIGS. 7A-7E for exact amounts, but the difference is slight.

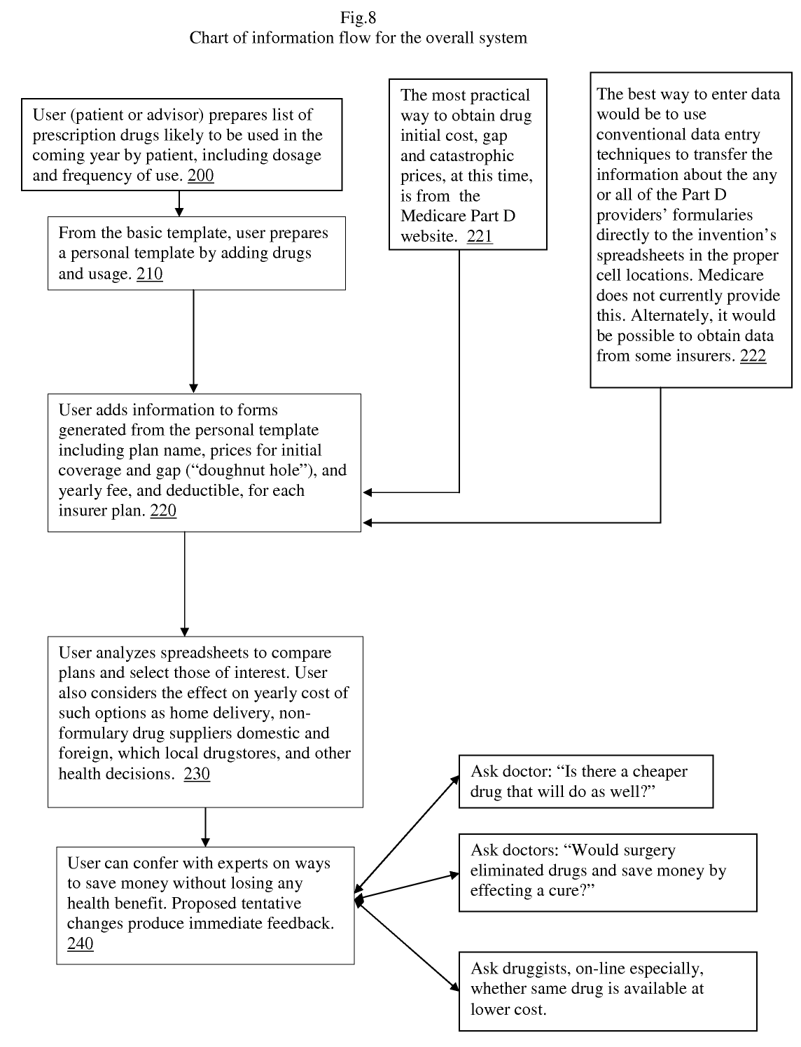

Referring to FIG. 8, the methodology of FIGS. 1-6 is summarized. In step 200, the user (patient or advisor) prepares list of prescription drugs likely to be used in the coming year by patient, including dosage and frequency of use. In step 210, the user prepares a personal template from the basic template by adding their selected drugs and usage.

In step 220, the user then adds information to the forms generated from the personal template including plan name, prices for initial coverage and gap (“doughnut hole”), and yearly fee, and deductible, for each insurer plan. At this time, as seen in step 221, the most practical way to obtain drug initial cost, gap and catastrophic prices is from the Medicare Part D website. As seen in step 222, the best way to enter data is to use conventional data entry techniques to transfer the information about the any or all of the Part D providers' formularies directly to the invention's spreadsheets in the proper cell locations. Medicare does not currently provide this. Alternatively, it would be possible to obtain data from some insurers.

In step 230, the user then analyzes the spreadsheets to compare plans and selects those of interest. The user may also want to consider the effect on yearly cost of such options as home delivery, non-formulary drug suppliers domestic and foreign, locality of drugstores, and other health decisions. In step 240, the user may then confer with experts on ways to save money without losing any health benefits. Proposed tentative changes produce immediate feedback on the spreadsheet.

The templates and forms herein disclosed may be stored by a processor of a computer in a computer memory such as in a computer file system or database. The templates and forms may be presented to a user through a display monitor of a computer and may be accessed through a user interface of a computer, such as a computer mouse and keyboard.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A method of analyzing the cost of prescription drugs comprising the steps of:
receiving personal information data from a user;
preparing a template by inputting the personal information data;
obtaining prescription drug formulary information from a plurality of prescription drug plans;
inserting the prescription drug formulary information into the template;
creating a spreadsheet for each healthcare provider containing the personal information data and the prescription drug formulary information; and
analyzing the spreadsheets to compare the prescription drug plans.

2. The method of claim 1 wherein the personal information data from the user is a list of prescription drugs to be taken by the user within a prescribed period of time.

3. The method of claim 2 wherein the list of prescription drugs includes a dosage requirement and a frequency of use.

4. The method of claim 2 wherein the prescribed period of time is a year.

5. The method of claim 1 wherein the prescription drug formulary includes a name of a plan to be evaluated, an initial cost for each prescription drug, a yearly plan fee, and a deductible to be met.

6. The method of claim 1 wherein analyzing the spreadsheets determines if the user has reached an initial coverage limit for the prescription drug plan.

7. The method of claim 1 further comprising the step of calculating an actual out of pocket cost of the prescription drug.

8. The method of claim 7 wherein calculating the actual out of pocket cost of the prescription drug determines if the user may avoid paying for the prescription drug at full cost.

9. The method of claim 7 wherein calculating the actual out of pocket cost of the prescription drug determines if the user may pay a reduced catastrophic coverage cost for the prescription drug.

10. A method of analyzing the cost of prescription drugs comprising the steps of:
receiving personal information data from a user;
preparing a template by inputting the personal information data using a computer system;
obtaining prescription drug formulary information from a plurality of prescription drug plans;
inserting the prescription drug formulary information into the template;
using the computer system to create a spreadsheet for each healthcare provider containing the personal information data and the prescription drug formulary information; and
analyzing the spreadsheets to compare the prescription drug plans.

11. A system for analyzing the cost of prescription drugs comprising:
a means for receiving personal information data from a user;
a means for preparing a template by inputting the personal information data;
a means for obtaining prescription drug formulary information from a plurality of prescription drug plans;
a means for inserting the prescription drug formulary information into the template;
a means for creating a spreadsheet for each healthcare provider containing the personal information data and the prescription drug formulary information; and
a means for analyzing the spreadsheets to compare the prescription drug plans.

12. The system of claim 11 wherein the personal information data from the user is a list of prescription drugs to be taken by the user within a prescribed period of time.

13. The system of claim 12 wherein the list of prescription drugs includes a dosage requirement and a frequency of use.

14. The system of claim 12 wherein the prescribed period of time is a year.

15. The system of claim 11 wherein the prescription drug formulary includes a name of a plan to be evaluated, an initial cost for each prescription drug, a yearly plan fee, and a deductible to be met.

16. The system of claim 11 wherein analyzing the spreadsheets determines if the user has reached an initial coverage limit for the prescription drug plan.

17. The system of claim 11 further comprising a means for calculating an actual out of pocket cost of the prescription drug.

18. The system of claim 17 wherein calculating the actual out of pocket cost of the prescription drug determines if the user may avoid paying for the prescription drug at full cost.

19. The system of claim 17 wherein calculating the actual out of pocket cost of the prescription drug determines if the user may pay a reduced catastrophic coverage cost for the prescription drug.
